(19) United States
(12) Patent Application Publication
(10) Pub. No.: US 2026/0214649 A1
(43) Pub. Date: Jul. 23, 2026

(54) METHOD AND APPARATUS FOR INDICATING UNUSED TRANSMISSION OCCASIONS

(71) Applicant: 1FINITY Inc., Kawasaki-shi (JP)

(72) Inventors: Su YI, Beijing (CN); Guorong LI, Beijing (CN)

(73) Assignee: 1FINITY Inc., Kawasaki-shi (JP)

(21) Appl. No.: 19/571,824

(22) Filed: Mar. 19, 2026

Related U.S. Application Data
(63) Continuation of application No. PCT/CN2023/122952, filed on Sep. 28, 2023.

(51) Int. Cl. H04W 72/0446; H04W 72/21

(52) U.S. Cl. CPC H04W 72/0446; H04W 72/21

(57) ABSTRACT

An apparatus includes: a receiver configured to receive a configuration message from a network device; and processor circuitry configured to determine whether a configured uplink grant in a multi- Physical Uplink Shared CHannel (PUSCH) Configured Grant (CG) is going to be used according to the configuration message via a MAC entity of the terminal equipment, and notify a lower layer of information on whether the configured uplink grant is going to be used, wherein the configuration message is a first configuration message, comprising a first information element, the first information element comprising a first field, the first field providing the number of consecutive slots allocated in one multi-PUSCH CG period, wherein, if the first field is configured, fields in a sub-information element rrc-ConfiguredUplinkGrant in the first information element are used to determine a time-domain resource configuration of a first configured uplink grant in the multi-PUSCH CG period.

### CROSS-REFERENCE TO RELATED APPLICATION

This application is a continuation application under 35 U.S.C. 111(a) of International Patent Application PCT/CN2023/122952 filed on Sep. 28, 2023, and designated the U.S., the entire contents of which are incorporated herein by reference.

### TECHNICAL FIELD

Embodiments of the present disclosure relate to the technical field of communications.

### BACKGROUND

In 3GPP (3rd Generation Partnership Project) services and networks, extended reality (XR) service is supported, the XR service refers to environment and human-computer interaction of all real and virtual combinations produced by computer technologies and wearable devices. Its application fields include but are not limited to entertainment, healthcare, education, etc. The XR service may comprise virtual reality (VR) service, augmented reality (AR) service and mixed reality (MR) service.

Virtual reality is a rendered version of a released visual and an audio scenario. When an observer or user moves within limitations defined by an application program, rendering aims to simulate visual and auditory sensory stimuli in the real world as naturally as possible. Augmented reality refers to providing a user with additional information or artificially generated items, or content overlaid on its current environment. Mixed reality is an advanced form of AR, in which some virtual elements are inserted into a physical scenario, with the aim of providing an illusion that makes people feel these elements are a part of a real scenario.

A PDU set consists of one or more PDUs (Protocol Data Units), these PDUs carry a valid payload of an information element generated at an application layer, such as a frame or video slice for XR and media services. In some implementations, the application layer requires all PDUs in the PDU Set to use corresponding information elements. In other implementations, when some PDUs are lost, the application layer may still recover all or part of the information elements.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

Inventor finds that in order to use resources more rationally, a UE may report subsequent unused transmission occasions (UTOs) via UCI (uplink control information), this UCI indication is called UTO-UCI. Under normal circumstances, the UE transmits UTO-UCI information via a physical layer to inform a base station of relevant information on next unused TOs. However, the physical layer has no capability to know which TOs will be used or unused next, because the physical layer has no buffer status information, thereby cannot estimate usage of TOs. Therefore, in uplink transmission, for how to determine usage of transmission occasions, further standardization and technical implementation need to be performed. Otherwise, UTO-UCI cannot work correctly, which may lead to waste of CG resources, thereby reducing transmission efficiency.

For at least one of the above problems or other similar problems, the embodiments of the present disclosure provide a method and apparatus for indicating unused transmission occasions, which supports how to promptly notify a physical layer of information on UTO by enhancing at least one of RRC related configurations and MAC related procedures based on characteristics of data burst in XR services.

According to an aspect of the embodiments of the present disclosure, an apparatus for indicating unused transmission occasions is provided, configured in a terminal equipment, the apparatus comprising:

a receiving unit, configured to receive a configuration message from a network device; and

a processing unit, configured to determine whether a configured uplink grant in a multi-PUSCH CG is used according to the configuration message at a MAC entity of the terminal equipment, and notify a lower layer of information on whether the configured uplink grant is used.

One of advantageous effects of the embodiments of the present disclosure is: according to the embodiments of the present disclosure, by performing uplink related enhancement at a MAC layer, a terminal equipment determines usage of subsequent TOs via a MAC entity and notifies a lower layer (i.e., a physical layer), the physical layer may thereby correctly generate and transmit UTO-UCI, such that a network side may perform further operations, such as allocating unused TOs to other terminal equipment, thereby increasing a network capacity. Thereby, the problem i.e., how a terminal equipment determines whether a TO in a multi-PUSCH CG is used, is solved, thereby a network side may effectively utilize scheduled resources. In addition, since no redundant signaling is introduced, signaling overhead is reduced, data burst characteristics of a XR service and a media service are supported, and improvement in a network capacity is achieved.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term "comprise/include" when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of an example of UTO-UCI;

FIG. 2 is a schematic diagram of a method for indicating unused transmission occasions in the embodiments of the present disclosure;

FIG. 3 is a schematic diagram of a multi-PUSCH CG period;

FIG. 4 is a schematic diagram of an apparatus for indicating unused transmission occasions in the embodiments of the present disclosure;

FIG. 5 is a schematic diagram of a terminal equipment in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term "first" and "second", etc. are used to distinguish different elements in terms of appellation, but do not represent a spatial arrangement or time sequence, etc. of these elements, and these elements should not be limited by these terms. The term "and/or" includes any and all combinations of one or more of the associated listed terms. The terms "include", "comprise" and "have", etc. refer to the presence of stated features, elements, members or components, but do not preclude the presence or addition of one or more other features, elements, members or components.

In the embodiments of the present disclosure, the singular forms "a/an" and "the", etc. include plural forms, and should be understood broadly as "a kind of" or "a type of", but are not defined as the meaning of "one"; in addition, the term "the" should be understood to include both the singular forms and the plural forms, unless the context clearly indicates otherwise. In addition, the term "according to" should be understood as "at least partially according to......", the term "based on" should be understood as "at least partially based on......", unless the context clearly indicates otherwise.

In the embodiments of the present disclosure, the term "a communication network" or "a wireless communication network" may refer to a network that meets any of the following communication standards, such as Long Term Evolution (LTE), LTE- Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term "a network device" refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.), an Integrated Access and Backhaul (IAB) node or an IAB-DU or IAB-donor. And the term "base station" may include their some or all functions, each base station may provide communication coverage to a specific geographic region. The term "cell" may refer to a base station and/or its coverage area, which depends on the context in which this term is used. In a case where there is no confusion, the terms "cell" and " base station" are interchangeable.

In the embodiments of the present disclosure, the term "User Equipment (UE)" or "Terminal Equipment (TE) or Terminal Device" refers to, for example, a device that accesses a communication network and receives network services through a network device. The terminal equipment can be fixed or mobile, and can also be referred to as Mobile Station (MS), a terminal, Subscriber Station (SS), Access Terminal (AT), IAB-MT (Mobile Terminal), a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera, a wearable device and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term "a network side" or "a network device side" refers to a side of a network, may be a base station, and may include one or more network devices as described above, or may further be a device in a core network. The term "a user side" or "a terminal side" or "a terminal equipment side" refers to a side of a user or terminal, may be a UE, and may include one or more terminal equipments as described above. If it is not specifically mentioned herein, "a device" may refer to a network device, or may refer to a terminal equipment.

At present, 5G technology is studying key issues, solutions and conclusions for supporting advanced media services, such as High Data Rate Low Latency (HDRLL) service, AR/VR/XR services and tactile/multimodal communication services. Goals include:

1. Supporting an enhanced function of a multi-mode service, including:

studying whether and how to enable an application program to provide users with relevant tactile and multi-mode data (such as audio, video and tactile data related to a specific time) at similar times, with a focus on a demand for enhanced policy control (such as QoS policy coordination).

2. Enhancing network exposure to support interaction between 5GS (a 5G system) and an application program, including:

studying whether and how to perform application synchronization and QoS (Quality of Service) policy coordination among multiple UEs or multiple QoS flows of each UE, and how to interact between AF and 5GS.

studying exposure of 5GS QoS information (such as QoS capabilities) and network conditions to an application program to achieve fast codec/rate adaptation, which helps to provide required QoE (for example, helping to alleviate 5GS congestion).

3. Studying whether and how to perform the following QoS and policy enhancements for XR service and media service transmission, including:

studying traffic characteristics of media services that can improve a network resource utilization rate and QoE (Quality of Experience).

enhancing a QoS framework to support PDU Set granularity (such as a video/audio frame/tile, an application data unit, control information), wherein the PDU Set consists of PDUs with the same QoS requirements.

by taking into account different importances of PDU Sets, supporting differentiated QoS processing. For example, a packet belonging to a less important PDU Set is legally discarded to reduce resource waste.

whether and how to support uplink-downlink transmission coordination to meet a RTT (Round Trip Time) delay requirement between N6 termination points from a UE to a UPF (User Plane Function).

potential policy enhancements to reduce jitter to the greatest extent, with a focus on demand supply from an AF (Application Function) and expansion of a PCC (policy and charging control) rule.

In order to support data burst characteristics of XR services and better pre-configure resources, an enhancement is currently proposed for an uplink scheduling method of a configured grant (CG). In a CG period, multi-PUSCH (Physical Uplink Shared CHannel) transmission occasions may be included, that is, in a CG configuration, multiple consecutive configured uplink grants are included within one period. The configured uplink grant may further be called a configured grant occasion (CGO), a transmission occasion (TO), PUSCH (Physical Uplink Shared Channel) transmission, a PUSCH occasion, a PUSCH transmission occasion, etc.

Since the multi-PUSCH CG is pre-configured, considering the characteristics of data burst, an excessive number of periodic uplink resources may be configured so that when large data bursts arrive, scheduling may be performed in a timely manner to reduce latency. However, this may lead to certain waste of resources sometimes. For example, data traffic may be relatively small for some periods, resulting in pre-configured resources not being utilized. In order to use resources more rationally, a UE may report subsequent unused transmission occasions (UTOs) via UCI (uplink control information), this UCI indication is called UTO-UCI. The meaning of "unused" is that it is not going to be used, is going to be unused, or is unused. "Used" means that it will be used, is going to be used, or is not unused.

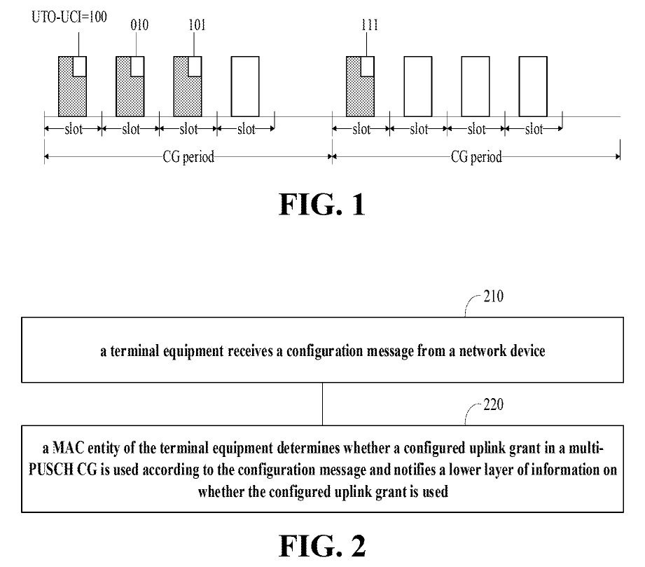

UE may multiplex UTO-UCI represented by an N-bit bitmap in each CG-PUSCH transmission. N bits in the UTO-UCI have a one-to-one mapping to N subsequent CG-PUSCH transmission occasions in ascending order of start time from lower bit to higher bit. A bit value of 0 indicates that the UE may transmit a CG-PUSCH at a corresponding CG-PUSCH transmission occasion, and a bit value of 1 indicates that the UE will not transmit the CG-PUSCH at the corresponding CG-PUSCH transmission occasion. FIG. 1 shows an example of using 3 bits of UTO-UCI to indicate in each CG-PUSCH transmission. In FIG. 1, each CG period is configured with four TOs. In FIG. 1, TO with a background color indicates a used (or called not unused) TO, and TO without a background color indicates an unused TO. In a bitmap of UTO-UCI, it is customary to have high bits on the left and low bits on the right.

Inventor finds that the UE transmits UTO-UCI information via a physical layer to inform a base station of relevant information on next unused TOs. However, the physical layer has no capability to know which TOs will be used or unused next, because the physical layer has no buffer status information, thereby cannot estimate usage of TOs. Therefore, in uplink transmission, for how to determine usage of transmission occasions, further standardization and technical implementation need to be performed. Otherwise, UTO-UCI cannot work correctly, which may lead to waste of CG resources, thereby reducing transmission efficiency.

For at least one of the above problems or other similar problems, the embodiments of the present disclosure provide a method and an apparatus for indicating unused transmission occasions. Embodiments of the present disclosure are described below in conjunction with the drawings and the specific implementations. In the following description, without causing confusion, "if..." may be replaced with "in a case where... "or" when...".

### Embodiments of a First Aspect

Embodiments of the present disclosure provide a method for indicating unused transmission occasions, which is described from a terminal equipment side.

FIG. 2 is a schematic diagram of a method for indicating unused transmission occasions in the embodiments of the present disclosure. As shown in FIG. 2, the method includes:

210: a terminal equipment receives a configuration message from a network device; and

220: a MAC entity of the terminal equipment determines whether a configured uplink grant in a multi-PUSCH CG is used according to the configuration message and notifies a lower layer of information on whether the configured uplink grant is used.

It should be noted that the above FIG. 2 only schematically describes the embodiments of the present disclosure, but the present disclosure is not limited to this. For example, other some operations can be increased or operations therein may be reduced. Persons skilled in the art may make appropriate modifications according to the above contents, not limited to the records in the above FIG. 2.

According to the above embodiments, a terminal equipment determines usage of subsequent TOs via a MAC entity and notifies a lower layer (i.e., a physical layer), the physical layer may thereby correctly generate and transmit UTO-UCI, such that a network side may perform further operations, such as allocating unused TOs to other terminal equipment, thereby increasing a network capacity.

In some embodiments, the configuration message is a first configuration message, such as an RRCReconfigurationmessage, comprising a first information element, such as an IE ConfiguredGrantConfig, the first information element comprising a first field, for example called numberOfPUSCH-PerPeriod or nrofSlots_InCGperiod, cg-nrofSlotsPerPeriod, cg-nrofPUSCH-PerPeriod, etc., the first field providing the number of consecutive slots allocated within a multi-PUSCH CG period.

In the above embodiments, by enhancing the IE ConfiguredGrantConfigin the RRCReconfiguration message, adding the above first field to provide the number of consecutive slots allocated within a multi-PUSCH CG period, which is able to support a configuration related to UTO-UCI of a multi-PUSCH CG.

In the above embodiments, the first field may be of integer type, and its value range may be from 2 to 16 or from 2 to 32, the present disclosure is not limited thereto.

In some implementations, if the first field is configured, the terminal equipment ignores configurations of cg-nrofSlotand cg-nrofPUSCH-InSlot. Since cg-nrofSlot is the number of slots allocated in a CG period and cg-nrofPUSCH-InSlotis the number of consecutive PUSCHs within a slot in a CG, these parameters are applicable to legacy CGs but not to multi-PUSCH CGs. Thereby, in a case where the first field is configured, the terminal equipment ignores the above two parameters, ensuring correctness of a configuration and avoiding conflicts with existing configuration parameters.

In some imlementations, if the first field is configured, fields in a sub-information element rrc-ConfiguredUplinkGrant in the first information element, such as timeDomainAllocation, timeDomainOffset, timeReferenceSFN, etc, are all used to determine a time-frequency resource configuration of a first configured uplink grant in the multi-PUSCH CG period. Thereby, existing configurations may be reused, saving signaling overhead.

In the above implementations, a time-domain position (symbol) of a subsequent i^{th} configured uplink grant in the multi-PUSCH CG period is increased by i slots in a time-domain position (symbol) of the first configured uplink grant. Thereby, it is only needed that one configured uplink grant is configured, and the UE calculates time-domain resource scheduling information of other configured uplink grants by itself, thereby reducing signaling overhead.

In the above embodiments, the first information element may further comprise a second field, for example called nrof_UTO_UCI, which is used to indicate the number of bits for reporting UTO-UCI for subsequent CG-PUSCH TOs (i.e., a TO of a PUSCH in a CG, called "TO" for short), corresponding to N introduced earlier.

In the above embodiments, the second field may be of integer type, and its value range may be from 3 to 8, the present disclosure is not limited thereto.

In the previous embodiments, by taking the first field and the second field being located in the IE ConfiguredGrantConfig as an example, the present disclosure is not limited thereto, the first field and the second field may further be located in a newly added IE of the RRCReconfigurationmessage, such as an IE specifically defined for a multi-PUSCH CG, etc., or located in an existing or newly added IE of other configuration message, the present disclosure is not limited thereto.

In some embodiments, since a physical layer needs to multiplex and transmit UTO-UCI in a CG-PUSCH of each transmission, the MAC entity of the terminal equipment may determine relevant information on whether subsequent TOs of the configured uplink grant are used before a start time of a current configured uplink grant, for example before a first symbol time of a configured uplink grant, and notify a lower layer of the relevant information on whether the subsequent TOs are used.

In the above embodiments, the MAC entity of the terminal equipment may perform the above notification when indicating the physical layer to generate transmission based on stored uplink grants or when obtaining a MAC PDU for transmission from a multiplexing and assembly entity or when transferring a configured uplink grant and an associated HARQ message to a HARQ entity or after a logical channel prioritization procedure is completed, etc.

In the above embodiments, when the MAC entity notifies the lower layer of the relevant information on whether the subsequent TOs are used, the MAC entity may further notify the lower layer of time reference information, the time reference information indicating a start moment of the relevant information on whether the subsequent TOs are used, that is, through the time reference information, indicating from which moment the notified information on whether the subsequent TOs are used begins.

In the above embodiments, the time reference information may be a specific time, for example denoted by a frame number, a subframe number, a slot, a symbol, etc., the present disclosure is not limited thereto, the time reference information may further be that start from which TO in a current multi-PUSCH CG period, or start from which configured uplink grant after the current configured uplink grant, and so on.

In the above embodiments, the relevant information on whether the subsequent TOs of the configured uplink grant are used (that is, usage or usage status of the subsequent TOs) may be determined through the following several methods, which are described respectively below.

In some implementations, the MAC entity of the terminal equipment determines usage of subsequent N TOs according to a current buffer status and notifies the lower layer of the usage of the N TOs. Here, N refers to a value of the second field.

For example, the terminal equipment calculates the number of TOs required for completing transmission of buffer data, according to a buffer status of one or more logical channels that are capable of being mapped to the multi-PUSCH CG, and a transport block size (TBS) corresponding to the TOs in the multi-PUSCH CG, that is, how may TOs are needed in the future to complete transmission of buffer data; then determines a usage status of the N TOs according to the calculated number and notifies a lower layer of usage of the N TOs.

In the above example, the multi-PUSCH CG is a multi-PUSCH CG that includes a current configured uplink grant; the buffer status refers to a sum of buffer sizes of the one or more logical channels. A buffer size of each logical channel is equal to a sum of a data volume of a corresponding PDCP layer and a data volume of a corresponding RLC layer.

In the above example, the MAC entity of the terminal equipment may determine usage of future N TOs when a MAC PDU is generated each time, and inform a lower layer.

In the above example, one or more logical channels that are capable of being mapped to the multi-PUSCH CG satisfy the following conditions:

if the multi-PUSCH CG is configured as type 1, the logical channel(s) need(s) to be configured as configuredGrandType1Allowed; and

if a logical channel is configured with an allowedCG-List, the allowedCG-List needs to include a value of ConfiguredGrantConfigIndexMAC configured by the multi-PUSCH CG.

Thereby, a buffer data volume of a logical channel belonging to this CG may be calculated accurately, thereby usage of subsequent TOs may be predicted accurately.

In the above example, when the MAC entity of the terminal equipment notifies the lower layer of the relevant information on whether the subsequent TOs are used, the following principle may further be followed, i.e., if one TO (i.e., a CG PUSCH occasion) is indicated as "UNUSED" in a previous notification, the TO is not able to be indicated as "USED" in a subsequent notification.

That is to say, for the same TO, if it is previously predicted that it would not be used, even if it is later predicted that the TO could be used due to the arrival of new data, the lower layer may still be notified that the TO is unused. That is, the terminal equipment can only give up using the TO. Unless otherwise specified, the above principle applies to other methods in the embodiments of the present disclosure.

According to the above implementations, it may be considered that the MAC entity of the terminal equipment generates a bitmap of UTO and notifies a physical layer, and the physical layer generates UTO-UCI completely according to an indication of a MAC layer. The present disclosure does not impose any restrictions on a specific content about the MAC entity notifies the lower layer, which may be a bitmap, or may inform which TOs are unused, or which TOs are used, etc.

In some other implementations, the MAC entity of the terminal equipment determines usage of all TOs in one multi-PUSCH CG period and notifies the lower layer of the usage before the first used TO in the multi-PUSCH CG period, for example before start of the multi-PUSCH CG period, i.e., before a start time of the first TO in the multi-PUSCH CG period.

For example, the MAC entity of the terminal equipment calculates the number of TOs required to complete transmission of buffer data according to a current buffer status; then, determines usage of all TOs in the multi-PUSCH CG period according to the calculated number, and notifies the lower layer of the usage.

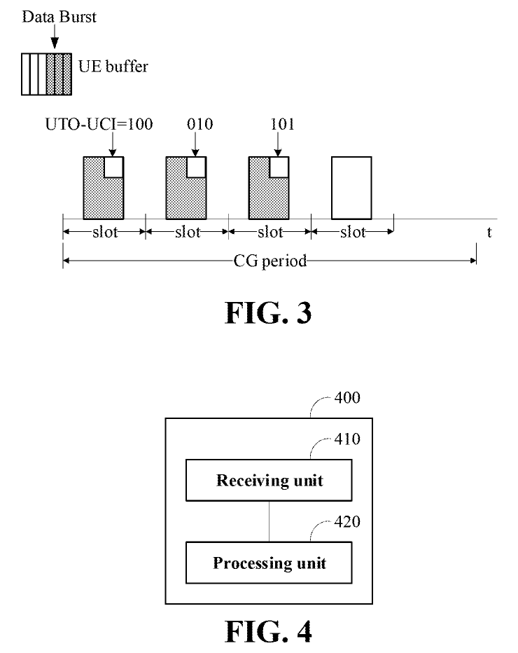

FIG. 3 is a schematic diagram of a multi-PUSCH CG period, as shown in FIG. 3, multi-PUSCH CG period (also called a CG period) is usually configured as a period of data burst. Uplink data bursts often arrive at user device buffer simultaneously or at close times. For example, at the beginning of the CG period, data burst has already arrived at the buffer of Layer 2. Therefore, the MAC entity of the terminal equipment may calculate the number of TOs required for data of the CG period according to a buffer status at this point. For a calculation method, the aforementioned implementations are referred to.

In the above implementations, the usage of all TOs in the CG period may be the number of TOs that still need to be used, the present disclosure is not limited thereto.

In the above implementations, the MAC entity of the terminal equipment may inform the lower layer of the usage when generating transmission data of a first configured uplink grant, for example inform the lower layer of the number of TOs further required for data burst. The present disclosure is not limited thereto. The MAC entity of the terminal equipment may further inform the lower layer of the usage at other times.

In the above implementations, a physical layer of the terminal equipment may generate corresponding UTO-UCI each time a PUSCH is transmitted, according to one indication received in each multi-PUSCH CG period, and transmit it to a network side. Thereby, the network side may perform further operations, such as allocating unused TOs to other terminal equipment, thereby increasing a network capacity.

In some further implementations, the MAC entity of the terminal equipment notifies the lower layer of an unused TO before a start time of the unused TO of the multi-PUSCH CG.

In the above implementations, since a state of an unused TO cannot be changed, it is better to inform the lower layer at a latest possible moment. However, the physical layer needs to transmit UTO-UCI information to the network side in advance so that the network side has sufficient processing time to schedule this TO for other terminal equipment. Therefore, in this implementation, a time threshold T may further be set, with unit being such as millisecond, the number of slots, the number of TOs, etc.

In the above implementations, before the time threshold T prior to the start time of the unused TO, if the MAC entity of the terminal equipment predicts that the TO is unused, it notifies the lower layer that the TO will not be used.

For example, assuming that the time threshold is T milliseconds, before T milliseconds prior to the start time of a certain TO, if the MAC entity predicts that the TO is unused, it notifies the lower layer that the TO will not be used. This notification method is similar to a sliding window, always notifying usage of TOs of a moment t+T at a moment t.

In the above implementations, the time threshold T may be configured by RRC signaling, indicating a minimum time advance that the MAC layer needs to notify the physical layer of an unused TO, or may be specified by a protocol, for example T=4 milliseconds.

In the above implementations, the physical layer of the terminal equipment considers that a TO is used before receiving an indication notified by the MAC entity that the TO is unused. That is, if the physical layer does not receive an indication from the MAC entity regarding UTO, it assumes that the following N TOs are all used.

In the above implementations, the physical layer may generate UTO-UCI according to a default situation and the indication from the MAC layer.

In some further implementations, when end of data burst appears in a certain logical channel, the MAC entity of the terminal equipment determines relevant information on unused TOs and notifies the lower layer of the relevant information on the unused TOs.

In the above implementations, when the end of data burst (EoDB, i.e., a last PDU in data burst) reaches a buffer queue of the logical channel, and the multi-PUSCH CG only includes the logical channel, the MAC entity of the terminal equipment considers that current data burst has all reached the buffer, it determines usage of subsequent TOs in the current multi-PUSCH CG period according to current buffer status. For example, the usage of subsequent TOs in the current multi-PUSCH CG period may be determined according to the method in the above implementations, description thereof is omitted here.

In some further implementations, when buffer(s) of one or more logical channels capable of being mapped to a multi-PUSCH CG is/are cleared, the MAC entity of the terminal equipment determines relevant information on unused TOs and notifies the lower layer of the relevant information on the unused TOs.

For example, after the buffer(s) of one or more logical channels is/are cleared or after waiting for a period of time after the buffer(s) is/are cleared, when the MAC entity of the terminal equipment determines that there is no data in the current multi-PUSCH CG period that may be transmitted, it notifies the lower layer that all subsequent TOs in the current multi-PUSCH CG period are unused TOs.

In some further implementations, the MAC entity of the terminal equipment determines usage of TOs in a multi-PUSCH CG according to a traffic pattern and/or historical information and/or statistical information, and notifies the lower layer of the usage. That is, the usage of TOs in the multi-PUSCH CG is determined based on implementation of the terminal equipment.

In the above implementations, similar to an information generation method when the terminal equipment reports UE Assistance Information about XR uplink traffic, a UE may predict future traffic according to a traffic pattern, historical information, measurement information, statistical information, etc., thereby obtaining an upcoming TO usage situation and notifying the lower layer.

In the above implementations, the physical layer of the terminal equipment may generate UTO-UCI according to relevant information on whether the TO received from an upper layer is used, and transmit the UTO-UCI together with PUSCH to the network device when transmitting the PUSCH next time.

Each of the above implementations only exemplarily describes the embodiments of the present disclosure, but the present disclosure is not limited thereto, appropriate modifications may be further made based on each of the above implementations. For example, each of the above implementations may be used individually, or one or more of the above implementations may be combined.

In the embodiments of the present disclosure, in order to support integrity of a PDU Set, a UE side may perform PDU Set-based data discarding. When the UE discards the PDU Set, a PDCP layer discards all PDUs in the PDU Set. At this point, Layer 2 buffer of the UE will undergo a significant change, which may affect usage of TOs, such as causing subsequent TOs to become unused.

For the above problem, the embodiments of the present disclosure further provide solutions.

In some embodiments, when performing PDU set discarding, a PDCP entity of the terminal equipment triggers the MAC entity to determine an unused TO, i.e., update usage of a TO, and notifies the lower layer of relevant information on the unused TO. Thereby, the above problem is solved.

In the above embodiments, when performing PDU set discarding, the PDCP entity of the terminal equipment may further notify the MAC entity of the amount of discarded data; thereby, the MAC entity may determine unused TOs according to the amount of discarded data, that is, predict UTO information.

In the embodiments of the present disclosure, during the process of data transmission and reception without dynamic scheduling, the uplink configuration may also be further enhanced. For example, enhancement is performed when the MAC entity configures uplink.

In some embodiments, for one configured uplink grant in one multi-PUSCH CG, if a TO corresponding to the configured uplink grant is indicated to the lower layer as an unused TO, the MAC entity of the terminal equipment releases or skips the configured uplink grant. Thereby, the terminal equipment maintains consistency of information indication and transmission behavior, ensuring correctness of an uplink configuration grant.

In some other embodiments, for TDD (unpaired spectral operation), the MAC entity of the terminal equipment does not indicate relevant information on an unused TO of an invalid configured uplink grant to the lower layer.

In the above embodiments, the invalid configured uplink grant refers to that a slot in which the configured uplink grant is located is a downlink slot, thus its corresponding TO is invalid for uplink scheduling. In this way, in various previous methods for determining relevant information on whether subsequent TOs of a configured uplink grant are used, when indicating the subsequent TOs, invalid TOs are directly skipped. For example, if the MAC entity determines that the subsequent two TOs are unused and the subsequent second TO is an invalid TO, it indicates that the subsequent first and third TOs are unused.

Each of the above embodiments is only illustrative for the embodiments of the present disclosure, but the present disclosure is not limited to this, appropriate modifications may be further made based on the above each embodiment. For example, each of the above implementations may be used individually, or one or more of the above embodiments may be combined.

According to the method in the embodiments of the present disclosure, the problem i.e., how a UE determines whether a TO in a multi-PUSCH CG is used, is solved, thereby a network side may effectively utilize scheduled resources. No redundant signaling is introduced, signaling overhead is reduced, data burst characteristics of a XR service and a media service are supported, and improvement in a network capacity is achieved.

### Embodiments of a Second Aspect

Embodiments of the present disclosure provide an apparatus for indicating unused transmission occasions. The apparatus may, for example, be a terminal equipment, or may be one or more parts or components configured in the terminal equipment. The apparatus in the embodiments of the present disclosure corresponds to the method in the embodiments of the first aspect, the contents same as those in the embodiments of the first aspect are not repeated.

FIG. 4 is a schematic diagram of an apparatus for indicating unused transmission occasions in the embodiments of the present disclosure. As shown in FIG. 4, an apparatus 400 for indicating unused transmission occasions in the embodiments of the present disclosure comprises:

a receiving unit 410, configured to receive a configuration message from a network device; and

a processing unit 420, configured to determine whether a configured uplink grant in a multi-PUSCH CG is used according to the configuration message via a MAC entity of the terminal equipment, and notify a lower layer of information on whether the configured uplink grant is used.

In some embodiments, the configuration message is a first configuration message, comprising a first information element, the first information element comprising a first field, the first field providing the number of consecutive slots allocated in a multi-PUSCH CG period.

In the above embodiments, the first configuration message may be an RRCReconfiguration message.

In the above embodiments, the first information element may be an IE ConfiguredGrantConfig.

In the above embodiments, if the first field is configured, the terminal equipment may ignore configurations of cg-nrofSlot and cg-nrofPUSCH-InSlot.

In the above embodiments, if the first field is configured, fields in a sub-information element rrc-ConfiguredUplinkGrant in the first information element are all used to determine a time-frequency resource configuration of a first configured uplink grant in the multi-PUSCH CG period.

In the above embodiments, a time-domain position of a subsequent i^{th} configured uplink grant in the multi-PUSCH CG period may be increased by i slots in a time-domain position of the first configured uplink grant.

In the above embodiments, the first information element may further comprise a second field, the second field being used to indicate the number of bits for reporting UTO-UCI for a subsequent CG-PUSCH TO.

In some embodiments, before a start time of a current configured uplink grants, the processing unit 420 determines relevant information on whether a subsequent TO of the configured uplink grant is used, via the MAC entity of the terminal equipment, and notifies a lower layer of the relevant information on whether the subsequent TO is used.

In the above embodiments, the processing unit 420 may further notify the lower layer of time reference information via the MAC entity of the terminal equipment, the time reference information indicating a start moment of the relevant information on whether the subsequent TO is used.

In the above embodiments, the processing unit 420 may determine usage of subsequent N TOs according to a current buffer status via the MAC entity of the terminal equipment and notify the lower layer of the usage of the N TOs.

For example, the processing unit 420 calculates the number of TOs required for being capable of completing transmission of buffer data, according to a buffer status of one or more logical channels that are capable of being mapped to the multi-PUSCH CG, and a transport block size corresponding to the TOs in the multi-PUSCH CG; and determines the usage of the N TOs according to the calculated number of the TOs and notifies the lower layer of the usage of the N TOs.

In the above example, the one or more logical channels that are capable of being mapped to the multi-PUSCH CG satisfy the following conditions:

if the multi-PUSCH CG is configured as Type 1, the logical channel(s) is/are configured as configuredGrandType1Allowed; and

if a logical channel is configured with an allowedCG-List, the allowedCG-List includes a value of ConfiguredGrantConfigIndexMAC configured by the multi-PUSCH CG.

In the above example and others examples, if one TO is indicated as "UNUSED" in a previous notification, the TO is not able to be indicated as "USED" in a subsequent notification.

In the above embodiments, the processing unit 420 may determine usage of all TOs in the multi-PUSCH CG period before the first used TO in the multi-PUSCH CG period, via the MAC entity of the terminal equipment, and notifies the lower layer of the usage.

For example, the processing unit 420 calculates the number of TOs required to complete transmission of buffer data according to a current buffer status; and determines usage of all TOs in the multi-PUSCH CG period according to the calculated number of the TOs, and notifies the lower layer of the usage.

In the above example, the processing unit 420 may generate corresponding UTO-UCI each time a PUSCH is transmitted, according to an indication received in each multi-PUSCH CG period, via a physical layer of the terminal equipment.

In the above embodiments, the processing unit 420 may further notify the lower layer of an unused TO, before a start time of an unused TO of the multi-PUSCH CG, via the MAC entity of the terminal equipment.

For example, before a time threshold T prior to the start time of the unused TO, if the MAC entity predicts that the TO is unused, it will notify the lower layer that the TO will not be used.

In the above example, the time threshold T may be configured by RRC signaling, and the time threshold T indicates a minimum time advance that the MAC layer needs to notify the physical layer of an unused TO.

In the above example, the processing unit 420 may consider that a TO is used before receiving an indication notified by the MAC entity that the TO is unused, via the physical layer of the terminal equipment.

In the above example, when end of data burst appears in a certain logical channel, the processing unit 420 may determine relevant information on an unused TO, via the MAC entity of the terminal equipment, and notify the lower layer of the relevant information on the unused TO.

For example, when end of data burst reaches the buffer of the logical channel, and the multi-PUSCH CG includes only the logical channel, the processing unit 420 determines usage of subsequent TOs in a multi-PUSCH CG period according to a current buffer status, via the MAC entity of the terminal equipment.

In the above embodiments, when buffer(s) of one or more logical channels capable of being mapped to the multi-PUSCH CG is/are cleared, the processing unit 420 may further determine relevant information on unused TOs, via the MAC entity of the terminal equipment, and notify the lower layer of the relevant information on the unused TOs.

In the above example, when the MAC entity determines that there is no data in the current multi-PUSCH CG period that may be transmitted, the processing unit 420 notifies the lower layer that all subsequent TOs in the current multi-PUSCH CG period are unused TOs.

In the above embodiments, the processing unit 420 may further determines usage of TOs in a multi-PUSCH CG according to a traffic pattern and/or historical information and/or statistical information, via the MAC entity of the terminal equipment, and notifies the lower layer of the usage of the TOs.

In the above example, the processing unit 420 may generate UTO-UCI according to relevant information on whether the TO received from an upper layer is used, via the MAC entity of the terminal equipment, and transmit the UTO-UCI together with PUSCH to the network device when transmitting the PUSCH next time.

In some embodiments, when performing PDU set discarding via a PDCP entity of the terminal equipment, the processing unit 420 triggers the MAC entity to determine an unused TO, and notifies the lower layer of relevant information on the unused TO.

In the above embodiments, when performing PDU set discarding, the processing unit 420 may notify the MAC entity of the amount of discarded data, via the PDCP entity of the terminal equipment; and the MAC entity determines unused TOs according to the amount of the discarded data.

In some embodiments, for one configured uplink grant in one multi-PUSCH CG, if a TO corresponding to the configured uplink grant is indicated to the lower layer as an unused TO, the processing unit 420 releases or skips the configured uplink grant via the MAC entity of the terminal equipment.

In the above embodiments, for TDD, the processing unit 420 does not indicate relevant information on an unused TO of an invalid configured uplink grant to the lower layer, via the MAC entity of the terminal equipment.

It's worth noting that the above only describes components or modules related to the present disclosure, but the present disclosure is not limited thereto. Apparatus 400 in the embodiments of the present disclosure may further comprise other components or modules. For detailed contents of these components or modules, relevant technologies may be referred to. Moreover, the above components or modules may be realized by a hardware facility such as a processor, a memory, a transmitter, a receiver, etc. The embodiments of the present disclosure have no limitation thereto.

According to the apparatus in the embodiments of the present disclosure, the problem i.e., how a UE determines whether a TO in a multi-PUSCH CG is used, is solved, thereby a network side may effectively utilize scheduled resources. No redundant signaling is introduced, signaling overhead is reduced, data burst characteristics of a XR service and a media service are supported, and improvement in a network capacity is achieved.

### Embodiments of a Third Aspect

Embodiments of the present disclosure further provide a communication system, comprising a network device and a terminal equipment.

In the embodiments of the present disclosure, the terminal equipment comprises the apparatus described in the embodiments of the second aspect, and is configured to perform the method described in the embodiments of the first aspect. Since each method has been described in details in the embodiments of the first aspect, its contents are incorporated here and are not repeated.

In the embodiments of the present disclosure, the network device transmits a configuration message to the terminal equipment, for example transmits the first configuration message to the terminal equipment. In addition, the network device may further receive information from the terminal equipment, such as the aforementioned UCI, PUSCH, etc. Since behaviors of the network device have been described in the previous embodiments, its contents are combined here and are omitted here.

In the above embodiments, the network device may further perform normal operations of a network device, and the network device may further perform operations corresponding to the operations of the terminal equipment, for example the network device receives information/signals from the terminal equipment, and/or the network device transmits information/signals to the terminal equipment, descriptions are omitted here.

Embodiments of the present disclosure further provide a terminal equipment, the terminal equipment for example may be a UE, but the present disclosure is not limited to this, it may also be other terminal equipment.

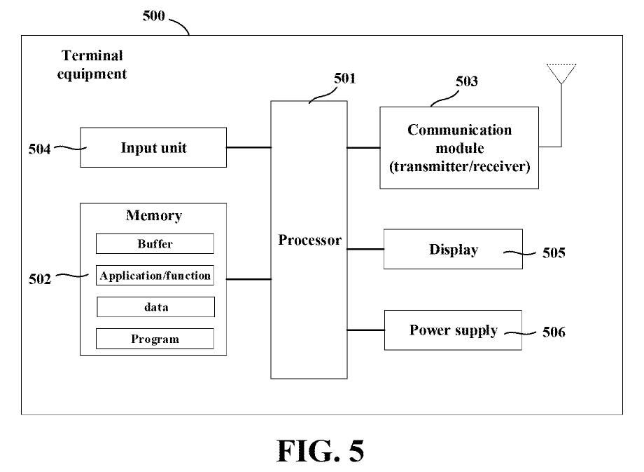

FIG. 5 is a schematic diagram of a terminal equipment in the embodiments of the present disclosure. As shown in FIG. 5, the terminal equipment 500 may comprise a processor 501 and a memory 502; the memory 502 stores data and programs, and is coupled to the processor 501. It's worth noting that this figure is exemplary; other types of structures may also be used to supplement or replace this structure, so as to realize a telecommunication function or other functions.

In some embodiments, functions of the apparatus 400 in the embodiments of the second aspect may be integrated into the processor 501, wherein the processor 501 may be configured to execute a program to implement the method as described in the embodiments of the first aspect, the contents of which are incorporated herein and are not described repeatedly here.

In some other embodiments, the apparatus 400 in the embodiments of the second aspect may be configured separately from the processor 501, for example the apparatus 400 in the embodiments of the second aspect may be configured as a chip connected to the processor 501, functions of the apparatus 400 in the embodiments of the second aspect are realized through the control of the processor 501.

As shown in FIG. 5, the terminal equipment 500 may further comprise: a communication module 503, an input unit 504, a display 505 and a power supply 506. The functions of said components are similar to related arts, which are not repeated here. It's worth noting that the terminal equipment 500 does not have to include all the components shown in FIG. 5, said components are not indispensable. Moreover, the terminal equipment 500 may also include components not shown in FIG. 5, relevant technologies can be referred to.

Embodiments of the present disclosure further provide a computer program, wherein when a terminal equipment executes the program, the program enables the terminal equipment to execute the method described in the embodiments of the first aspect.

Embodiments of the present disclosure further provide a storage medium in which a computer program is stored, wherein the computer program enables a terminal equipment to execute the method described in the embodiments of the first aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:

1. A method for indicating unused transmission occasions, wherein the method includes:

a terminal equipment receives a configuration message from a network device; and

a MAC entity of the terminal equipment determines whether a configured uplink grant in a multi-PUSCH CG is used according to the configuration message and notifies a lower layer of information on whether the configured uplink grant is used.

2. The method according to supplement 1, wherein,

the MAC entity of the terminal equipment determines relevant information on whether a subsequent TO of the configured uplink grant is used, before a start time of a current configured uplink grants, and notifies the lower layer of the relevant information on whether the subsequent TO is used.

3. The method according to supplement 2, wherein,

the MAC entity of the terminal equipment further notifies the lower layer of time reference information, the time reference information indicating a start moment of the relevant information on whether the subsequent TO is used.

4. The method according to supplement 2, wherein,

the MAC entity of the terminal equipment calculates the number of TOs required to complete transmission of buffer data according to a current buffer status;

the terminal equipment determines usage of all TOs in the multi-PUSCH CG period according to the calculated number of the TOs, and notifies the lower layer of the usage.

5. The method according to supplement 2, wherein,

a physical layer of the terminal equipment generates corresponding UTO-UCI each time a PUSCH is transmitted, according to an indication received in each of the multi-PUSCH CG periods.

6. The method according to supplement 2, wherein,

before a time threshold T prior to the start time of the unused TO, if the MAC entity predicts that the TO is unused, it will notify the lower layer that the TO will not be used.

7. The method according to supplement 6, wherein,

the time threshold T is configured by RRC signaling, and the time threshold T indicates a minimum time advance that the MAC layer needs to notify the physical layer of an unused TO.

8. The method according to supplement 2, wherein,

the physical layer of the terminal equipment considers that a TO is used before receiving an indication notified by the MAC entity that the TO is unused.

9. The method according to supplement 2, wherein,

when end of data burst appears in a certain logical channel, the MAC entity of the terminal equipment determines relevant information on unused TOs and notifies the lower layer of the relevant information on the unused TOs.

10. The method according to supplement 2, wherein,

when buffer(s) of one or more logical channels capable of being mapped to the multi-PUSCH CG is/are cleared, the MAC entity of the terminal equipment determines relevant information on unused TOs and notifies the lower layer of the relevant information on the unused TOs.

What is claimed is:

1. An apparatus for indicating unused transmission occasions (TOs), configured in a terminal equipment, the apparatus comprising:
a receiver configured to receive a configuration message from a network device; and
processor circuitry configured to determine whether a configured uplink grant in a multi- Physical Uplink Shared CHannel (PUSCH) Configured Grant (CG) is going to be used according to the configuration message via a MAC entity of the terminal equipment, and notify a lower layer of information on whether the configured uplink grant is going to be used,
wherein the configuration message is a first configuration message, comprising a first information element, the first information element comprising a first field, the first field providing the number of consecutive slots allocated in one multi-PUSCH CG period,
wherein, if the first field is configured, fields in a sub-information element rrc-ConfiguredUplinkGrant in the first information element are used to determine a time-domain resource configuration of a first configured uplink grant in the multi-PUSCH CG period.

2. The apparatus according to claim 1, wherein,
the first configuration message is RRCReconfiguration message; and
the first information element is an IE ConfiguredGrantConfig.

3. The apparatus according to claim 1, wherein,
if the first field is configured, the processor circuitry ignores configurations of cg-nrofSlot and cg-nrofPUSCH-InSlot.

4. The apparatus according to claim 1, wherein,
fields in the sub-information element rrc-ConfiguredUplinkGrant include timeDomainOffset timeReferenceSFN and timeDomainAllocation.

5. The apparatus according to claim 4, wherein,
a time-domain position of a subsequent i^{th} configured uplink grant in the multi-PUSCH CG period is increased by i slots in a time-domain position of the first configured uplink grant.

6. The apparatus according to claim 1, wherein,
the first information element further comprises a second field, the second field being used to indicate the number of bits for reporting Unused Transmission Occasion – Uplink Control Information (UTO-UCI) for subsequent CG-PUSCH TOs.

7. The apparatus according to claim 6, wherein,
the processor circuitry determines relevant information on whether a subsequent TO of the configured uplink grant is going to be used, via the MAC entity of the terminal equipment, and notifies the lower layer of the relevant information on whether the subsequent TO is going to be used.

8. The apparatus according to claim 7, wherein,
the processor circuitry determines usage of subsequent N TOs according to a current buffer status via the MAC entity of the terminal equipment and notifies the lower layer of the usage of the N TOs, wherein, N is the number indicated by the second field in the first information element.

9. The apparatus according to claim 8, wherein,
the processor circuitry calculates the number of TOs required for being capable of completing transmission of buffer data, according to a buffer status of one or more logical channels that are capable of being mapped to the multi-PUSCH CG, and a size of a transfer block corresponding to the TOs in the multi-PUSCH CG; and
the processor circuitry determines the usage of the N TOs according to a calculated number of the TOs and notifies the lower layer of the usage of the N TOs.

10. The apparatus according to claim 9, wherein,
the one or more logical channels that are capable of being mapped to the multi-PUSCH CG satisfy the following conditions that:
if the multi-PUSCH CG is configured as Type 1, the logical channel(s) is(are) configured as configuredGrandType1Allowed; and
if a logical channel is configured with an allowedCG-List, the allowedCG-List includes a value of ConfiguredGrantConfigIndexMAC configured by the multi-PUSCH CG.

11. The apparatus according to claim 8, wherein,
if one TO is indicated as "UNUSED" in a previous notification, the TO is not able to be indicated as "USED" in a subsequent notification.

12. The apparatus according to claim 7, wherein,
the processor circuitry determines usage of all TOs in one multi-PUSCH CG period, before the first used TO in the multi-PUSCH CG period, via the MAC entity of the terminal equipment, and notifies the lower layer of the usage.

13. The apparatus according to claim 7, wherein,
the processor circuitry notifies the lower layer of an unused TO before a start time of the unused TO in the multi-PUSCH CG via the MAC entity of the terminal equipment.

14. The apparatus according to claim 7, wherein,
the processor circuitry generates UTO-UCI according to relevant information received from an upper layer on whether a TO is going to be used, via a physical layer of the terminal equipment, and transmits the UTO-UCI multiplexed in each CG PUSCH transmission to the network device.

15. The apparatus according to claim 1, wherein the apparatus further comprises:
when performing PDU set discarding, the processor circuitry triggers the MAC entity to determine an unused TO via a PDCP entity of the terminal equipment, and notifies the lower layer of relevant information on the unused TO.

16. The apparatus according to claim 1, wherein,
for one configured uplink grant, if a TO corresponding to the configured uplink grant is indicated to the lower layer as an unused TO, the processor circuitry skips the configured uplink grant via the MAC entity of the terminal equipment.

17. The apparatus according to claim 1, wherein,
for unpaired spectrum operation, the processor circuitry does not indicate relevant information on an unused TO of an invalid configured uplink grant to the lower layer via the MAC entity of the terminal equipment.

18. An apparatus for indicating unused transmission occasions (TOs), configured in a network device, the apparatus comprising:
a transmitter configured to transmit a configuration message to a terminal equipment, wherein whether a configured uplink grant in a multi- Physical Uplink Shared CHannel (PUSCH) Configured Grant (CG) is going to be used is determined according to the configuration message via a MAC entity of the terminal equipment; and
a receiver configured to receive a CG-PUSCH from the terminal equipment, the CG-PUSCH corresponding to a configured uplink grant determined to be used according to the configuration message via the MAC entity of the terminal equipment;
wherein the configuration message is a first configuration message, comprising a first information element, the first information element comprising a first field, the first field providing the number of consecutive slots allocated in one multi-PUSCH CG period,
wherein, if the first field is configured, fields in a sub-information element rrc-ConfiguredUplinkGrant in the first information element are used to determine a time-domain resource configuration of a first configured uplink grant in the multi-PUSCH CG period.

19. A communication system, comprising:
a network device; and
a terminal equipment,
wherein the network device is configured to transmit a configuration message to the terminal equipment,
the terminal equipment is configured to determine whether a configured uplink grant in a multi- Physical Uplink Shared CHannel (PUSCH) Configured Grant (CG) is going to be used according to the configuration message via a MAC entity of the terminal equipment, and notify a lower layer of information on whether the configured uplink grant is going to be used,
wherein the configuration message is a first configuration message, comprising a first information element, the first information element comprising a first field, the first field providing the number of consecutive slots allocated in one multi-PUSCH CG period,
wherein, if the first field is configured, fields in a sub-information element rrc-ConfiguredUplinkGrant in the first information element are used to determine a time-domain resource configuration of a first configured uplink grant in the multi-PUSCH CG period.
